(19) United States
(12) Patent Application Publication
(10) Pub. No.: US 2006/0144031 A1
(43) Pub. Date: Jul. 6, 2006

(54) Picking-cutting device attached to the hand

(76) Inventors: Alfons Alber, Voran (IT); Gunther Thomas Kuhn, Meran (IT)

Correspondence Address: CHRISTIE, PARKER & HALE, LLP, PO BOX 7068, PASADENA, CA, 91109-7068, US

(21) Appl. No.: 11/317,905

(22) Filed: Dec. 22, 2005

Related U.S. Application Data
(63) Continuation of application No. PCT/CH03/00575, filed on Aug. 25, 2003.

(30) Foreign Application Priority Data
Jun. 23, 2003 (CH) 1092/03

(51) Int. Cl. A01D 46/00

(52) U.S. Cl. 56/328.1

(57) ABSTRACT

The invention relates to a cutting device that is secured on the hand for picking fruit, in particular for pressure sensitive fruit. In one embodiment, the connection between the scissors and the hands and fingers enables the picker to feel the surface and stalk of the fruit with his or her fingers in order to guide the scissors into the best position for cutting the stalk. The cutting element may then be spoon-shaped in such a way that the severed fruit stalk does not project beyond the surface of the fruit. The cutting element may comprise support elements and be fixed to at least one finger using suitable fixing means.

### CROSS-REFERENCE TO RELATED APPLICATION(S)

The present application is a continuation of the International Patent Application Serial No. PCT/CH2003/000575, filed Aug. 25, 2003, which claims the benefit of the filing date of Swiss Patent Application No. 1092/03, filed on Jun. 23, 2003, which are incorporated herein by reference in their entirety.

### FIELD OF THE INVENTION

The present invention relates to picking fruits. In particular, the present invention relates to a picking-cutting device for harvesting fruits.

### BACKGROUND OF THE INVENTION

Apples may be picked by hand and must all be harvested with the stem, because apples without the stem spoil rapidly; however, but long stems of many types of apples cause puncture and pressure damage on other apples during storage. Picking scissors have been proposed for use with citrus fruits in particular. Picking scissors are also used sometimes with apples, but these require both hands for cutting off an apple, or using scissors which hold the apple on the stem as it is cut off. A stem which is too long can nevertheless remain on the apple, which may in turn damage other apples.

### SUMMARY OF THE INVENTION

The present invention provides a picking-cutting device which is attachable to the finger and hand. Using the device, an apple may be held with one hand and simultaneously cut off, without the apple suffering pressure damage. In this case, the stem is cut through in such a way that it may not cause any puncture or pressure damage to other apples.

In the present case, the device is a picking-cutting device which is attached to a finger and hand. The fruit surface and the fruit stem (9) are touched using the finger and the fruit stem (9) is thus introduced into the cutting element (1). The fruit stem is then cut off using the spoon-like cutting element at the lowest possible point.

### BRIEF DESCRIPTION OF THE DRAWINGS

Illustrations of possible picking-cutting devices attached to the hand are shown in the figures.

FIG. 01 is an isometric view of a picking-cutting device constructed according to an embodiment of the invention;

FIG. 02 is an elevational view of a picking-cutting device constructed according to another embodiment of the invention, in position on the hand of a user and

FIG. 03 is a top plan view of a picking-cutting device according to a further embodiment of the invention, also in position on the hand of a user.

### DETAILED DESCRIPTION OF THE INVENTION

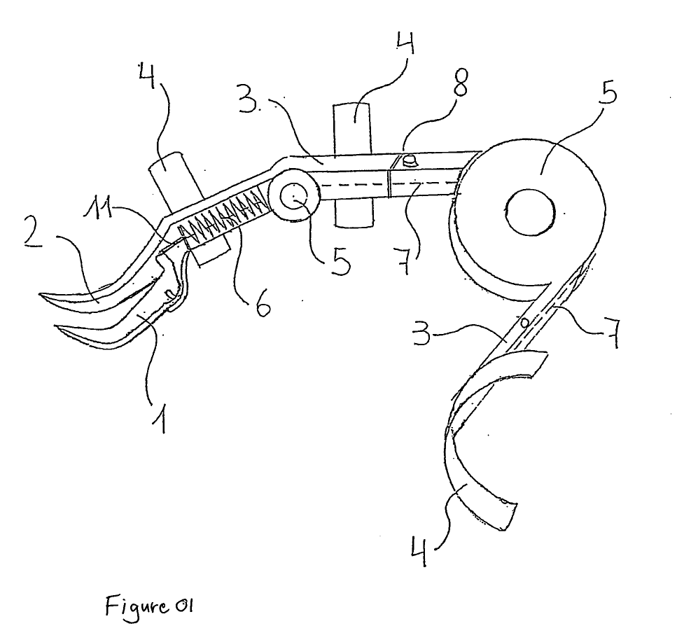

FIG. 01 is a picking-cutting device which is mechanically operated using the index finger and thumb of a user. This device is equipped with a support element (3) and joint (5) and a telescopic alteration mechanism (8). Force is transmitted via an inwardly-directed lip (7) onto the cutting element (1). The force transmitting lip may be made of inflexible materials and/or a flexible member having high tensile strength. In addition, the cutting element or the force transmitting lip may be provided with a spring or other restoring means for returning the cutting element to its initial position after a cut is completed.

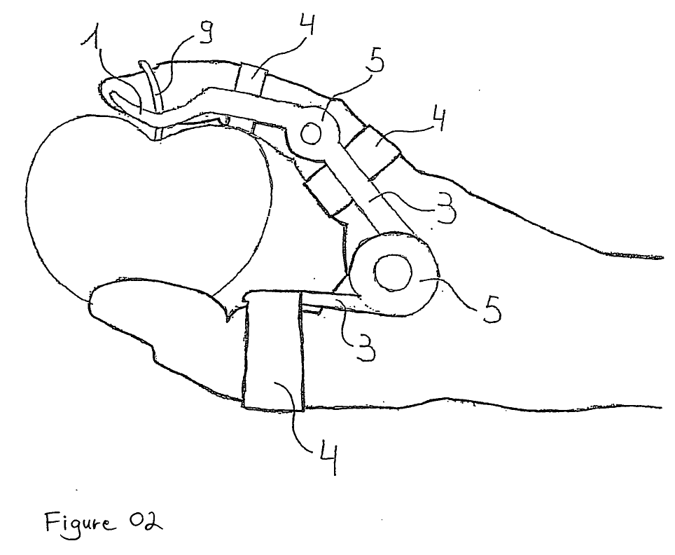

FIG. 02 is a picking-cutting device attached to the hand of a user having a spoon-shaped cutting element (1) in order to cut through the fruit stem (9) near the stem attachment. The support element (3) is attached to at least one finger using suitable fasteners (4), which may be partially rigid or deformable.

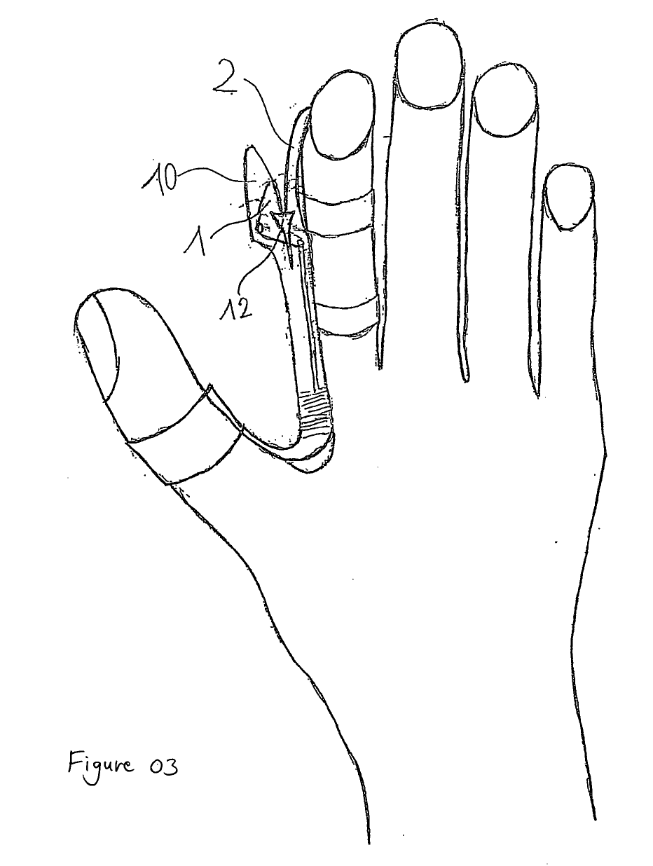

FIG. 03 is a picking-cutting device attached to the hand of a user, which is equipped with a protector (10) around the cutting element (1) and a counter cutting element (2), which is tailored to the finger. A triggering pin (12) is attached to the cutting element, which triggers the application of force on the cutting element when it hits the stem.

This picking-cutting device attached to the hand is a spoon-shaped cutting element having a counter cutting element or plate which may squeeze the stem of the fruit to be picked. The cutting element is constructed on a flexible or rigid support having at least one interposed joint. The supports are equipped with at least one attachment orientation. The picking-cutting device is attached to finger and thumb using fasteners. In addition, the support may be implemented as telescopic in order to be adapted to the finger length. The application of force to the cutting element is performed via the movement of the finger, particularly the thumb, or by an external or existing source of power. The external source of power may be a pre-tension force device (such as a spring, as indicated by the numeral 6 in FIG. 01), or a pneumatic, electrical or hydraulical device triggered directly by a fruit stem acting against a triggering pin (such as the triggering pin 12 of FIG. 03), or by hand or finger movement.

What is claimed is:

1. A picking-cutting device, which is attachable to a hand, for harvesting pressure-sensitive fruits,
wherein at least a part of the stem of the cut-off fruit remains as the fruit is cut off, implemented from at least one moving cutting element having a counterpart, which has a counter cutting element for cutting or a plate for squeezing the fruit stem of the fruit to be picked, the cutting element and the counter element are positioned on a rigid or flexible support, the support being implemented with at least one attachment device for attachment to at least one finger, the movement and application of force for the movable cutting element being performed using force transmission means which move the cutting element directly or indirectly through movement of the fingers or an existing source of power.

2. The picking-cutting device according to claim 1,
wherein the cutting element and counter cutting element are implemented as spoon-shaped in order to cut through apple stems in the fruit depression, so that the apple stems do not exceed the overall height of the apple.

3. The picking-cutting device according to claim 1,
wherein the cutting element is enclosed by a protector and the counter cutting element or plate is tailored to the shape of the finger.

4. The picking-cutting device according to claim 1,
wherein the support is implemented as a flexible and/or rigid element having at least one interposed joint and is telescopically extendable or retractable and equipped with inwardly-directed force transmission means, at least one partially rigid or deformable fastener being attached to the particular section.

5. The picking-cutting device according to claim 1,
wherein the force transmission means are made of at least one of inflexible materials and at least one flexible lip having high tensile strength.

6. The picking-cutting device according to claim 1,
wherein the movement and the application of force to the cutting element is performable mechanically through movement of at least one finger or hand pressure.

7. The picking-cutting device according of claim 1,
wherein the movement and the application of force to the cutting element is performed through pre-tension of the restoring means.

8. The picking-cutting device according to claim 1,
wherein the force transmission on the transmission means, and the cutting element is performed at least one of pneumatically, electrically, and hydraulically from at least one source of power.

9. The picking-cutting device according to claim 1,
wherein the movement and the application of force to the cutting element from at least one of a pre-tension force, pneumatically, electrically, hydraulically is triggered directly by the fruit stem stopping on a triggering pin or by hand or finger movement.

10. The picking-cutting device according to claim 1,
wherein it is made of metal and deformable materials and the cutting element or the force transmission means, are provided with restoring means.

11. Method of picking a fruit, the method comprising the steps of:
providing a picking-cutting device of claim 1;
approaching the picking-cutting device to a stem of the fruit and the fruit;
activating a cutting element of the picking-cutting device; and
holding the fruit.
